(19) United States
(12) Patent Application Publication
(10) Pub. No.: US 2007/0210709 A1
(43) Pub. Date: Sep. 13, 2007

(54) Micro discharge type plasma display device

(75) Inventors: Sanghoon Yim, Yongin-si (KR); Yoonchang Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd, Suwon-si (KR)

(21) Appl. No.: 11/515,898

(22) Filed: Sep. 6, 2006

(30) Foreign Application Priority Data
Sep. 7, 2005 (KR) 2005-83110

(51) Int. Cl. H01J 17/49

(52) U.S. Cl. 313/582

(57) ABSTRACT

A plasma display device includes: a dielectric layer on which a plurality of through-holes of a dielectric layer is disposed in a matrix shape; upper and lower electrode layers formed at both upper and lower surfaces of the dielectric layer; upper and lower substrates disposed on the outer surface of the upper and lower electrode layers; and a third electrode layer having a plurality of third electrodes which are formed between the upper substrate and the upper electrode layer, or the lower substrate and the lower electrode layer, and are insulated from the upper and lower electrode layers. Accordingly, a plasma display device can be realized which has stability and efficiency of a micro discharge. In addition, each pixel can concurrently carry out a sustain discharge by applying an alternating voltage to upper and lower electrodes forming sustain electrodes.

### CROSS-REFERENCE TO RELATED APPLICATION

This application claims the benefit of Korean Application No. 2005-83110, filed Sep. 7, 2005 in the Korean Intellectual Property Office, the disclosure of which is incorporated herein by reference.

### BACKGROUND OF THE INVENTION

1. Field of the Invention

Aspects of the present invention relate to a plasma display device, and more particularly, to a micro discharge type plasma display device with electrodes having through-holes in a pattern, where the electrodes are disposed on opposing surfaces of an insulating layer on which a plurality of through-holes are also arranged in a matrix form.

2. Description of the Related Art

Generally, plasma display panels are formed in such a way that a barrier rib and a driving electrode are formed between two substrates facing each other. The substrates are overlapped to define a specific gap. A discharge gas is infused in the gap and the edges of the substrates are sealed. A plasma display device is a flat type display device containing a plasma display panel and installed elements required to implement a screen, such as a driving circuit connected to each electrode of the panel.

In a plasma display panel, a number of pixels to implement the screen is vertically and horizontally arranged in a periodical and regular manner in a matrix pattern. Each pixel is driven in a manual matrix manner in which a voltage is simply applied to electrodes without any active elements to drive the pixels. There are different types of plasma display panels. The plasma display panel can be classified into either a direct current (DC) type or an alternating current (AC) type according to the type of a voltage signal used for driving each electrode. In addition, the plasma display panel can be classified into either a face type or a surface discharge type according to the disposition of two electrodes to which a discharge voltage is applied.

Also, types of plasma discharge used for a surface emission of the plasma display panel may be a micro discharge (MD) or a micro hollow cathode discharge (MHCD).

FIG. 1 is a schematic side cross-sectional view of a conventional micro discharge structure.

There are numerous types of micro discharge structures and the micro discharge structure of FIG. 1 is an open-type micro discharge structure. The micro discharge structure of FIG. 1 includes an upper layer 10, a lower layer 30, and an intermediate layer 20. The upper and lower layers 10, 30 are electrode layers to which a voltage is applied. The intermediate layer 20 is a dielectric layer which forms a spacing between the two electrode layers 10, 30. Through-holes 40 are formed in a plurality of sections through the upper and lower electrode layers 10, 30 and the dielectric layer 20. The upper and lower electrodes of the layers 10, 30 are flat except for through-hole portions, and are integrated to each other. Thus, when a voltage of a specific level or higher is applied to the electrodes 10, 30, a surface discharge occurs between the two electrodes 10, 30 in the through-holes 40. A plasma discharge may occur stably and effectively due to the surface discharge in the through-holes 40 when the through-hole size is suitably formed.

Light is emitted from the space of the through-hole 40 in which the surface discharge occurs. A phosphor layer (not shown) is generally formed at an inner surface of the through-hole 40 to enhance optical efficiency. The micro discharge may occur in a specific gas atmosphere. The micro discharge is a type of surface emission, and may even be used as a backlight source of a display device not of a plasma display type, such as a liquid crystal display (LCD).

The micro discharge structure having the structure of FIG. 1 is similar to a typical capacitor in which a dielectric layer 20 is inserted between two electrodes 10 and 30. Thus, when an alternating current (AC) is applied between the two electrodes 10 and 30, a substantial amount of power may be wasted due to parasitic capacitance.

Considering that the plasma discharge occurs stably and effectively in the through-holes 40 when the sizes of the through-holes 40 are suitably formed, and the micro discharge structure of FIG. 1 is similar to that of a basic matrix type plasma display device, a plasma display device may be produced using various micro discharge structures.

### SUMMARY OF THE INVENTION

Aspects of the present invention include a plasma display device which can display all pixels with a three-electrode structure while using a micro discharge structure.

Aspects of the present invention also include a plasma display device of a micro discharge type capable of increasing discharge efficiency and stability, and having a wide viewing angle.

Aspects of the present invention also include a plasma display device of a micro discharge type capable of lessening deterioration of a phosphor material during a face discharge.

According to an aspect of the present invention, there is a plasma display device comprising: a dielectric layer on which a plurality of through-holes of a dielectric layer is disposed in a matrix shape; upper and lower electrode layers formed at both upper and lower surfaces of the dielectric layer; upper and lower substrates disposed on the outer surface of the upper and lower electrode layers; and a third electrode layer having a plurality of third electrodes that are formed between the upper substrate and the upper electrode layer, or the lower substrate and the lower electrode layer, and are insulated from the electrode layers.

A circuit may be formed in the upper and lower electrode layers and the third electrode to apply an electric signal thereto, respectively.

The upper electrode layer and/or the lower electrode layer may be formed in a first direction of the matrix with some length, include a plurality of electrodes that are parallel to one another and have a group of through-holes arranged in the first direction in the electrode layers, and comprise the upper substrate disposed above the upper electrode layer and the lower substrate disposed below the lower substrate layer.

The third electrode layer may comprise a plurality of third electrodes that are parallel to one another and formed with some length in a second direction forming a specific angle with respect to the first direction with the third electrodes being insulated from the upper electrode due to the insulating layer, and face through-holes arranged in the second direction in the upper electrode layer through the plurality of electrodes of the upper electrode layer, that is, upper electrodes, or which are formed with some length in a second direction with the third electrodes being insulated from the lower electrode due to the insulating layer, and face through-holes arranged in the second direction in the lower electrode layer through the plurality of electrodes of the lower electrode layer, that is lower electrodes.

When the upper and lower electrode layers comprise a plurality of electrodes that are respectively formed in the first and second directions of the matrix and are parallel to one another, the electrodes of the third electrode layer may be formed in the first direction in addition to the second direction. For example, when the upper electrode layer is formed in the first direction, and the lower electrode layer is formed in the second direction, the third electrode layer may be formed above the upper electrode in the second direction, or below the lower electrode in the first direction.

When the upper electrode or the lower electrode is formed in the first direction with some length, each electrode may include a group of through-holes arranged in the first direction in each electrode layer. Each electrode may include separate electrodes formed around the group of through-holes arranged in the first direction and a connecting portion that connects the separate electrodes. The plurality of electrodes forming the same electrode layer may be parallel to one another. The group of through-holes arranged in the first direction may form a straight line directed in the first direction when drawing a line connecting all through-holes. However, the present invention is not limited thereto. For example, the group of through-holes of the present invention may include a group of through-holes arranged in a zigzag manner.

Through-holes of the dielectric layer may have a grid arrangement in which all through-holes are arranged in a simple matrix shape such as a checker, or may have a delta arrangement in which through-holes of upper and lower rows are arranged in an oblique direction so that adjacent through-holes can form triangles.

According to an aspect of the present invention, there is a display panel, including: a first electrode pattern having one or more electrodes with a first hole portion; a second electrode pattern having one or more electrodes with a second hole portion; and a dielectric layer having a through-hole and formed between the first and second electrode patterns, wherein the first hole portion, the second hole portion, and the through-hole are coaxial, and a discharge occurs between the electrodes of the first and second electrode patterns to emit light, and the material between each electrode of each pattern is removed to reduce parasitic capacitance.

According to an aspect of the present invention, there is a plasma display device including: a dielectric layer comprising a plurality of through-holes arranged in a matrix; upper and lower electrode layers disposed respectively at upper and lower surfaces of the dielectric layer; and a plurality of third electrodes disposed so as to be insulated from the upper or lower electrode layer by an insulating layer; wherein the upper electrode layer and/or the lower electrode layer include a plurality of electrodes extending in a first direction, each of the plurality of electrodes associated with a group of through-holes arranged in the first direction, and the plurality of third electrodes extending in a second direction at an angle with respect to the first direction.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a schematic side cross-sectional view illustrating a conventional micro discharge structure;

FIG. 2 is a side view of a cross-section of a plasma display device according to an aspect of the present invention;

FIGS. 3 to 6 are plan views of an upper electrode layer, a lower electrode layer, a dielectric layer, and a third electrode layer, respectively, of a plasma display device according to an aspect of the present invention;

FIG. 7 is a cross-sectional side view of a plasma display device according to another aspect of the present invention;

FIGS. 8 to 10 are plan views of an electrode structure according to an aspect of the present invention; and

FIG. 11 shows a common electrode according to another aspect of the present invention.

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

FIG. 2 is a cross-sectional side view of a plasma display device according to an aspect of the present invention.

To form the layer structure shown in FIG. 2, a third electrode pattern 250 may be formed on a lower substrate 190, and an insulating layer 170 may be laminated thereon. Thereafter, an overlay or a patterning of a lower electrode 130 (referred to as the lower electrode), a dielectric layer 120, an overlay or a patterning of an upper electrode 110 (referred to as the upper electrode), and an upper substrate 180 may be sequentially arranged and laminated above one another, and edge portions of the substrates 180, 190 may be sealed, thereby forming the layer structure of FIG. 2. In an aspect of the present invention, each layer of the structure shown in FIG. 2 is independently formed, and then laminated. In another aspect of the present invention, the lower substrate 190 and the lower electrode 130, and the upper substrate 180 and the upper electrode 110 may be integrated to each other. The dielectric layer 120 may be also integrated with the upper substrate 180 or the lower substrate 190 by lithography or photolithography. In various aspects, the overlay or patterning of the upper and lower electrodes 110, 130 may be a film or a layer, although it is preferred that the upper and lower electrodes 110, 130 are patterns without filled materials in between the electrodes 110, 130.

FIGS. 3 to 6 are plan views of an upper electrode layer, a lower electrode layer, a dielectric layer, and a third electrode layer, respectively, of a plasma display device according to an aspect of the present invention.

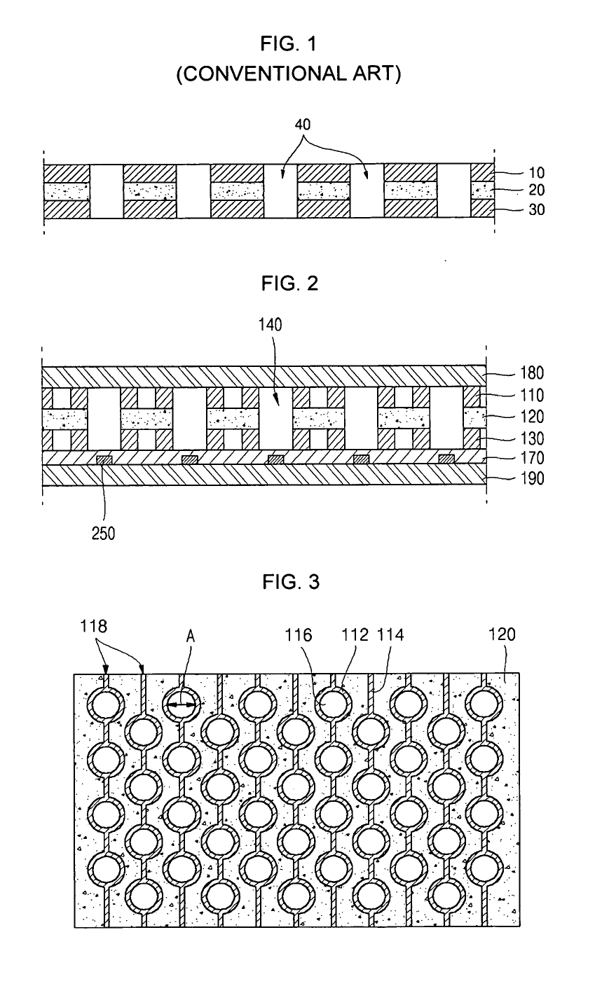

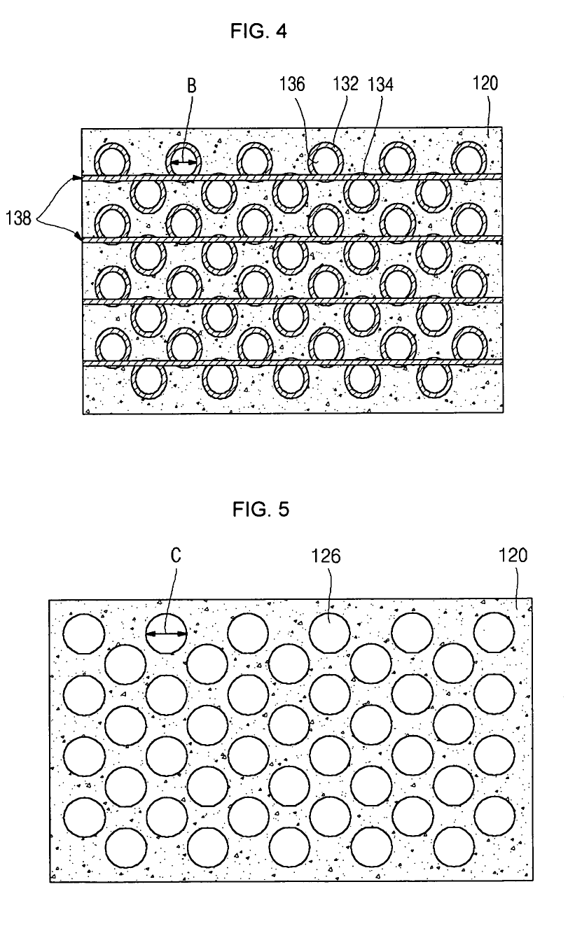

To reduce parasitic capacitance in the micro discharge structure, aspects of the present invention employ a similar structure as that of a matrix type plasma display device of FIG. 1. However, as shown in FIGS. 3 and 4, portions other than electrodes 118 and 138, the connecting portions 114 and 134, and electrodes 112 and 132 around the through-hole portions in the respective upper and lower substrates 180, 190 are removed.

In various aspects, a connecting portion 114 of the upper electrode 110 may be formed vertically as shown in FIG. 3, or horizontally, thereby forming a group of the upper electrodes 118. Similarly, a connecting portion 134 of the lower electrode 130 may be formed approximately perpendicular to the upper electrode 118 thereby forming a group of the lower electrodes 138 as shown in FIG. 4. In order for a through-hole 126 of the dielectric layer 120 to have a delta arrangement (i.e., a triangular configuration) as shown in FIG. 5, the lower electrode 138 of FIG. 4 includes the linear type connecting portion 134 horizontally formed and a separate electrode portion 132 to enclose a through-hole 136. A plurality of the through-holes 136 is arranged in a zigzag manner to alternate between positions above and below the linear type connecting portion 134. Nevertheless, as a whole, the lower electrodes 138 are formed horizontally, and the through-holes 136 of the lower electrode 138 are arranged as a group of through-holes that are generally arranged horizontally. Although shown as circular, the separate electrode portions 112 and 132 enclosing the respective through-holes 116 and 136 may be any shape. Examples include oval, rectangular, or parallelogram shapes or the like. The through-holes 126 formed in the dielectric layer 120 may also have a corresponding or matching shape.

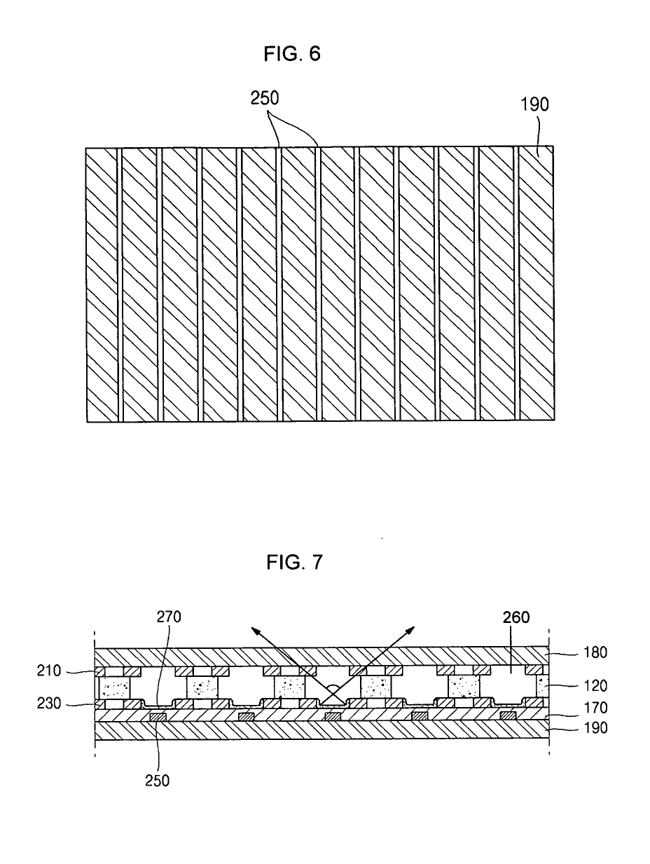

A third electrode or electrodes 250 as shown in FIGS. 2 and 6 may be considered as an address electrode or electrodes, and be connected to each electrode output of an address driver. The lower electrode 138 may be considered as a scan electrode, and be connected to each electrode output of a scan driver. When a negative voltage is applied to a first of the scan electrodes 138, for example, located at the top of FIG. 4, and a positive voltage is applied to a first of the address electrodes 250 located at the leftmost position of the layer 190 and a third of the address electrodes 250 located at the third leftmost position in the layer 190 in FIG. 6, an electric potential difference sufficient for a discharge occurs. Accordingly, an address discharge then occurs in the arranged through-holes of the first row at the first and the second of the address electrodes 250 of FIG. 4.

Thereafter, when a voltage is applied to each address electrode 250 located in an area to be displayed while the voltage is sequentially applied to second and third of the scan electrodes 138 of FIG. 4, an address discharge occurs in the corresponding through-holes. By scanning all of the through-holes in this manner, electric charge is accumulated in the dielectric material of the dielectric layer 120 near the electrodes 118, 138 facing the through-holes according to whether the discharge occurred in each through-hole.

After addressing is completed, a constant voltage is commonly applied to all of the scan electrodes 138 of FIG. 4 for a specific time, and the constant voltage is then commonly applied to all electrodes 118 of FIG. 3. This process is repeated as many times as required, so that each display discharge occurring in the through-holes represents one sub-field in one frame. A gradation display using such frame and sub-field is well-known to those skilled in the art. Accordingly, a detailed description thereof will be omitted.

In various aspects of the present invention, when the same electrical signals are to be concurrently applied to all of the upper electrodes 118 of FIG. 3 to use the upper electrodes 118 only as common electrodes, the upper electrodes 118 of FIG. 3 may have the same shape as that of the lower electrodes 138 of FIG. 4, or the dielectric layer 120 of FIG. 5.

When most of the visible light generated by the discharge is to be emitted through the upper substrate 180, the third electrode 250 is formed on the lower substrate 190 to increase an aperture ratio. Since the insulating layer 170 containing the third electrode 250 does not decrease the aperture ratio, it may be formed with an opaque metal having high reflectivity and good conductivity.

The substrates 180 and 190 are respectively disposed on the outer surface of the upper and lower electrodes 110 and 130 of FIG. 2 to seal the inside of the substrates 180, 190. Sealing is performed at edge portions of the substrates 180, 190. At this time, a discharge space is formed inside the substrates 180, 190 and is sealed except for an exhaust outlet (not shown). The air inside is then exhausted, and a discharge gas is infused therein with a desired pressure. Then, the exhaust outlet is sealed. By doing so, when a voltage is applied, the electrodes, 110, 130, for example, can be prevented from being oxidized and deteriorated, which may occur when the electrodes 110, 130, for example, are exposed to oxygen if the air is not exhausted. The discharge gas may be used to increase electrode evaporation and to enhance discharge efficiency. As examples of the main ingredient of the discharge gases, noble gases such as xenon and/or neon are usable.

FIG. 7 is a side view of a cross-section of a substrate of a plasma display device according to another aspect of the present invention.

In contrast to the aspect of FIG. 2, the aspect of FIG. 7 includes upper and lower separate electrodes 210 and 230 that are protruding more to the axial center of a through-hole 260 than the portion of the dielectric layer 120 sandwiched between the electrodes 210 and 230 within the through-hole 260. The protruded portion of the electrodes 210, 230 enable improved discharge efficiency since a face discharge may occur between portions of the upper and lower electrodes 210 and 230 that face each other across the dielectric layer 120.

A phosphor layer 270 is shown in FIG. 7, which is not shown in FIG. 2. The phosphor layer 270 may enable a color display, improve color display characteristics, and increase discharge efficiency, which are not available when light is generated only by using discharge gas characteristics. The phosphor layer 270 may be formed on the interior surfaces of the upper and lower substrates 180, 190, in the interior annular surfaces of the upper and lower electrodes 210, 230, in the through-holes 260, and/or in the interior surfaces of the dielectric layer 120. In various aspects of the present invention, the phosphor layer 270 may be formed anywhere except the surfaces of the protruding portion of the electrodes 210, 230 that face each other.

When visible light is emitted in one direction, or mostly upwards, the electrode 210 may be formed to be transparent so that a viewing angle may be widened as shown in FIG. 7. As shown in FIG. 7, at least the protruded portion of the electrode 210 is preferably formed with the transparent electrode. It is understood that the electrode 210 has a separate electrode portion that is shaped like the separate electrode 112 enclosing the through-hole 116 of the electrode layer in the upper electrode 118 of FIG. 3.

Referring now to FIGS. 3 to 7, the protruding portions of the upper and lower electrodes 210, 230 will be discussed in greater detail. When the through-hole 126 (also indicated by C in FIG. 5) is enlarged in the dielectric layer 120 that is the intermediate layer, and the through-holes 116 (also indicated by A in FIG. 3) and the through-holes 136 (also indicated by B in FIG. 4) in respective separate electrodes 112 and 132 of the upper electrode 110 and/or the lower electrode 130 are reduced, the size of the through-holes 126 do not coincide with the sizes of the through-holes 112 and 132. Accordingly, a portion of the separate electrodes 112 and 132 would protrude from the upper and lower portions of the through-hole 140 of FIG. 2 towards the center of the through-hole due to the enlarged upper and lower separate electrodes 112 and 132 relative to the through-hole 126 of the dielectric layer 120. In the protruded portion, a face surface would be formed between the protruded electrodes 112 and 132. The protruded portion is clearly shown in FIG. 7. In FIG. 7, when a voltage is applied to the upper and lower electrodes 210 and 230 corresponding to the upper and lower separate electrodes 112 and 132, a face discharge can occur. When the face discharge occurs, discharge efficiency may be improved. This is because the face discharge can occur between the upper and lower electrodes 210, 230 at an electric potential difference lower than when a surface discharge occurs at the same separation distance.

In various aspects of the present invention, the plasma display panel has a durability suitable for a display device. To form a phosphor layer 270 or a third electrode layer 250 as shown in FIG. 7, an upper substrate 180 and a lower substrate 190 are disposed on a basic three-layer construction of the micro discharge structure. The space formed between the substrates 180, 190 is sealed by sealing the edge portions of the substrates 180, 190, removing air including oxygen from the space, and infusing a discharge gas therein.

A number of through-holes 260 is formed through the dielectric layer 120 and the upper and lower electrodes 210 and 230, and both ends thereof are blocked by the substrates 180, 190, thereby forming a discharge cell. In the discharge cell, the phosphor layer 270 covers an annular side surface of the separate electrodes of the upper and lower electrodes 210, 230 (which are like the separate electrodes 112 of FIG. 3 and 132 of FIG. 4) facing the through-holes 260. The phosphor layer 270 covers the inner surface of the upper and lower substrates 180 and 190 for example, in addition to the annular side surface of the upper and lower electrodes 210 and 230. When light is emitted mostly through the upper substrate 180, and the upper substrate 180 constitutes a screen, then the phosphor layer 270 covering the inner surface of the upper substrate 180 is preferably made of a light transmitting phosphor.

In the phosphor layer structure discussed above, the phosphor layer 270 is not applied, formed, and/or laminated on an area where the upper and lower electrodes 210, 230 face each other on the protruding portion so that deterioration of the phosphor layer 270 is minimized when a face discharge occurs. In addition, effects of a discharge voltage dependent on characteristics of the phosphor layer can be minimized. Examples of such effects include the way a dielectric constant of the phosphor layer varies depending on the component elements used to produce different color lights.

To form the phosphor layer 270 having the layer structure of the aspects of the invention, the phosphor layer 270 may be coated or otherwise formed on portions of each through-hole such as 260 by lithography when an electrode pattern (or electrodes 210, 230) having through-holes is formed on substrates (such as 180, 190). In considering the stepped structure of the micro discharge structure having the substrates, an ink-jet application method is advantageous over a photolithography method to apply the phosphor layer 270 in aspects of the present invention.

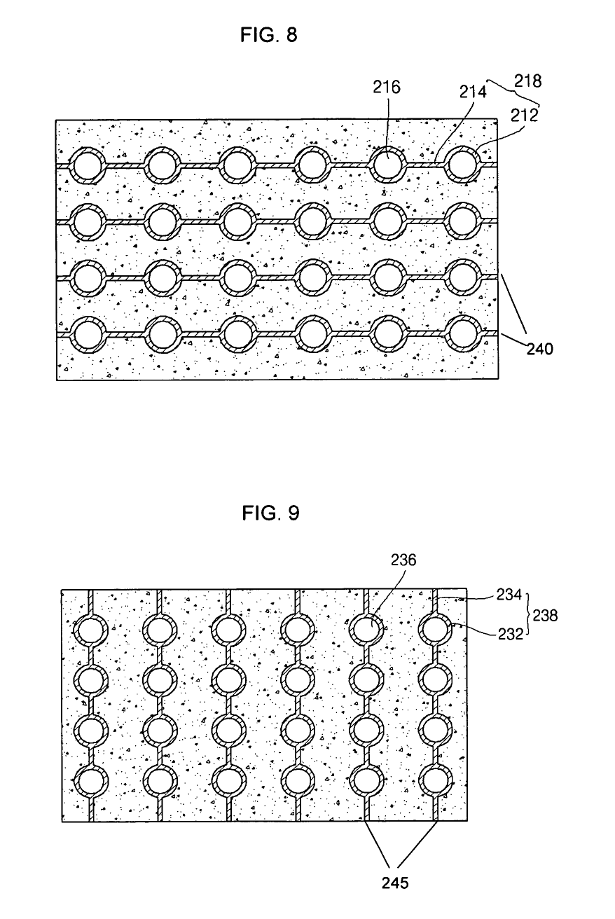

FIGS. 8 to 10 are plan views of an electrode structure according to another aspect of the present invention.

Unlike the delta shaped structure of FIGS. 3 to 5, through-holes in this aspect have a grid matrix structure. The through-holes 216 and 236 that determine the positions of each pixel of a display screen are located at grid points where electrodes arranged vertically (electrodes 238) and horizontally (electrodes 218) cross each other. Assuming that a plurality of electrodes vertically formed as shown in FIG. 9 are lower electrode or electrodes 238, and a plurality of electrodes horizontally formed as shown in FIG. 8 are upper electrode or electrodes 218, the through-holes 216 and 236 are formed at the position where the lower electrode 238 and the upper electrode 218 cross each other.

Similarly to FIG. 3, the upper electrode 218 is formed by connecting the upper separate electrodes 212, which are horizontally formed and enclose the through-hole 216 of the upper electrode layer or pattern 240, to the connecting portions 214. The lower electrode 238 is formed by connecting the lower separate electrodes 232, which are vertically formed and enclose the through-hole 236 of the lower electrode layer or pattern 245, to the connecting portions 234.

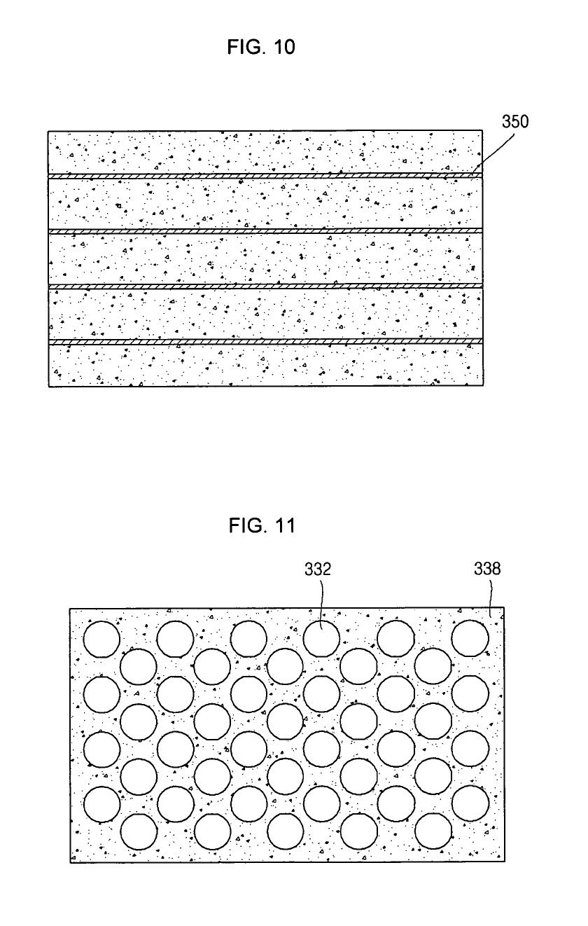

In the aspect of the present invention of FIGS. 8-10, ends of all upper electrodes 218 may be connected to one another to function as a common electrode, while the lower electrodes 238 formed vertically with some length may function as a data electrode, and separate third electrodes 350 formed horizontally as shown in FIG. 10 may function as a scan electrode.

FIG. 11 shows a common electrode 338 according to another aspect of the present invention. In contrast to FIG. 11, FIG. 8 shows that ends of a plurality of upper electrodes 218 formed horizontally are connected to one another, and a same signal is applied thereto, as shown in FIG. 8. Yet, the upper electrodes 218 remain distinct. In FIG. 11, the common electrode 338 is formed as a plate so that through-holes 332 are formed in designated areas of the common electrode 338. Thus, even when the common electrode 338 has a plate shape and an array of through-holes 332 as shown in FIG. 11, the common electrode 338 can carry out the same function of applying a common signal.

The layer structure of FIGS. 2 to 11 may be formed in various ways. For example, the upper and lower electrode layers may be formed in such a way that the upper and lower electrode layers, the third layer, and the insulating layer are formed first on the upper and lower substrates, respectively, and thereafter, a separately formed dielectric layer is arranged and laminated, and then edge portions of the substrates are sealed.

Alternatively, a substrate including only a third electrode layer and an insulating layer, upper and lower electrode layers, and dielectric layer may be separately formed, and thereafter, all of the layers may be arranged and laminated in a proper order, and the edge portions of the substrates may be then sealed. The manufacturing method, the layer material, connection between each electrode and a driving circuit, and circuit elements are well-known to those skilled in the micro discharge field or the plasma display field. Accordingly, detailed descriptions thereof will be omitted.

According to aspects of the present invention, a plasma display device may have stability and efficiency of a micro discharge.

In addition, a plasma display device may have reliability and simplicity of structure.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device comprising:
a dielectric layer on which a plurality of through-holes of a dielectric layer is disposed in a matrix pattern;
upper and lower electrode patterns formed respectively at upper and lower surfaces of the dielectric layer;
upper and lower substrates disposed on each outer surface of the upper and lower electrode patterns; and
an electrode layer having a plurality of third electrodes formed between the upper substrate and the upper electrode pattern, or the lower substrate and the lower electrode pattern, and insulated from the upper or lower electrode patterns,
wherein, the upper electrode pattern and/or the lower electrode pattern are formed in a first direction of the matrix pattern with some length, and include a plurality of electrodes which are parallel to one another and have a group of through-holes arranged in the first direction in the electrode patterns,
and the plurality of third electrodes which are parallel to one another, and
are formed with some length in a second direction of the matrix pattern, and forming a specific angle with respect to the first direction, and the third electrodes being insulated from the upper electrodes due to the insulating layer, and facing through-holes arranged in the second direction in the upper electrode pattern through the plurality of electrodes of the upper electrode pattern, or
are formed with some length in a second direction, and the third electrodes being insulated from the lower electrodes due to the insulating layer, and facing through-holes arranged in the second direction in the lower electrode pattern through the plurality of electrodes of the lower electrode pattern.

2. The plasma display device according to claim 1, wherein one of the upper and lower electrode patterns has a shape of a plate through which through-holes are formed.

3. The plasma display device according to claim 1, wherein the upper electrode patterns formed in the first direction are parallel to one another, and the lower electrode pattern is formed with a plurality of lower electrodes that are formed in the second direction and are parallel to one another.

4. The plasma display device according to claim 3, wherein the electrode layer is formed on the outer surface of the upper electrode in the second direction, or on the outer surface of the lower electrode in the first direction.

5. The plasma display device according to claim 1, wherein the first electrode and/or the second electrode comprise separate electrodes enclosing the through-holes in the electrode layer and a connecting portion that connects the separate electrodes.

6. The plasma display device according to claim 1, wherein the through-holes of the dielectric layer have a grid arrangement or a delta arrangement.

7. The plasma display device according to claim 1, further comprising a phosphor layer, wherein the phosphor layer is formed on at least a portion of a surface of the dielectric layer facing the through-holes and/or on the interior surface of the through-holes of the electric layer.

8. The plasma display device according to claim 1, wherein the through-holes of the dielectric layer are bigger than the through-holes of the electrodes in the upper electrode pattern and/or the lower electrode pattern, so that at least a portion of the upper and lower electrode patterns protrudes towards the center axis of the through-holes of the dielectric layer with respect to the inner surface of the through-holes of the dielectric layer.

9. The plasma display device according to claim 8, further comprising a phosphor layer, wherein the phosphor layer is formed only on the inner surface of the through-holes of the electrode patterns and the inner surface of the substrate facing the through-holes of the electrode patterns in the upper electrode pattern and/or the lower electrode pattern.

10. The plasma display device according to claim 1, wherein the through-holes of the electrodes are smaller than the through-holes of the dielectric layer in the upper electrode pattern, and
at least a portion that protrudes towards the center axis of the through-holes of the dielectric layer with respect to the inner surface facing the through-holes of the dielectric layer in the upper electrode pattern is formed with a transparent electrode.

11. The plasma display device according to claim 1, wherein at least a portion enclosing the layer through-holes of the upper electrodes in the upper electrode pattern is formed with a transparent electrode.

12. The plasma display according to claim 1, wherein the specific angle is about 90°.

13. A display panel, comprising:
a first electrode pattern having one or more electrodes with a first hole portion;
a second electrode pattern having one or more electrodes with a second hole portion; and
a dielectric layer having a through-hole and formed between the first and second electrode patterns, wherein the first hole portion, the second hole portion, and the through-hole are coaxial, and a discharge occurs between the electrodes of the first and second electrode patterns to emit light, and the material between each electrode of each pattern is removed to reduce parasitic capacitance.

14. The display panel according to claim 13, wherein the sizes of the first and second hole portions are smaller than the size of the through-hole such that protruding portions relative to the through-hole are formed by each of the first and second hole portions, and the discharge occurs between the protruding portion across the through-hole.

15. The display panel according to claim 13, wherein a shape of the first hole portion, the second hole portion, and the through-hole are non-circular.

16. The display panel according to claim 13, further comprising a first substrate and a second substrate, wherein the first substrate is formed on the first electrode pattern on a side opposite to the dielectric layer and the second substrate is formed on the second electrode pattern on a side opposite to the dielectric layer.

17. The display panel according to claim 13, further comprising a third electrode facing the interior of the through-hole and positioned perpendicularly to a central axis of the through-hole.

18. The display panel according to claim 13, wherein some or all of the electrodes of the first and second electrode patterns are transparent.

19. The display panel according to claim 13, further comprising a phosphor layer coated in a portion of the first hole portion, the second hole portion, and the through-hole.

20. A plasma display device comprising:
a dielectric layer comprising a plurality of through-holes arranged in a matrix;
upper and lower electrode layers disposed respectively at upper and lower surfaces of the dielectric layer; and
a plurality of third electrodes disposed so as to be insulated from the upper or lower electrode layer by an insulating layer;
wherein the upper electrode layer and/or the lower electrode layer include a plurality of electrodes extending in a first direction, each of the plurality of electrodes associated with a group of through-holes arranged in the first direction,
and the plurality of third electrodes extending in a second direction at an angle with respect to the first direction.
